(19) United States
(12) Patent Application Publication
(10) Pub. No.: US 2014/0009411 A1
(43) Pub. Date: Jan. 9, 2014

(54) TACTILE DISPLAY DEVICE AND METHOD

(71) Applicant: KOREA INSTITUTE OF SCIENCE AND TECHNOLOGY, Seoul (KR)

(72) Inventors: Il Joo CHO, Seoul (KR); Kyoung Hwan Na, Uiwang (KR); Eui Sung Yoon, Seoul (KR); Jei Won Cho, Uiwang (KR)

(73) Assignee: KOREA INSTITUTE OF SCIENCE AND TECHNOLOGY, Seoul (KR)

(21) Appl. No.: 13/749,179

(22) Filed: Jan. 24, 2013

(30) Foreign Application Priority Data
Jul. 3, 2012 (KR) 10-2012-0072371

(51) Int. Cl. G06F 3/041

(52) U.S. Cl. CPC G06F 3/0412
USPC 345/173

(57) ABSTRACT

The tactile display device of the present disclosure includes: an actuator which is movable in a vertical direction when an electric current or a pneumatic force is applied thereto; and a body made of flexible material and having a receiving unit for receiving the actuator and a fluid channel allowing a pneumatic force from an outside to be transferred to the receiving unit, wherein a membrane made of flexible material and capable of vertical displacement is attached to an upper end of the receiving unit of the body, and the actuator is coupled to a lower portion of the membrane so that the membrane and the actuator have the same vertical displacement.

### CROSS-REFERENCE TO RELATED APPLICATION

This application claims priority to Korean Patent Application No. 10-2012-0072371, filed on Jul. 3, 2012, and all the benefits accruing therefrom under 35 U.S.C. §119, the contents of which in its entirety are herein incorporated by reference.

### BACKGROUND

1. Field

The present disclosure relates to a tactile display device and method, and more particularly, to a tactile display device and method with a flexible structure which is closely adhered to a human body to effectively transfer tactile sensation.

2. Description of the Related Art

A tactile display device is an interface between a human and a machine, which may reproduce tactile parameters such as shape, surface texture, roughness and temperature. Therefore, the tactile display device may be provided to interact with machines such as computers and mobile devices in a virtual reality system.

In relation to the tactile display device, U.S. Pat. No. 8,013,847 discloses a driver for providing tactile information to a person, which is implemented by using a magnetic driving method and includes a magnetic core, a coil, a damper or the lime. In addition, US 2011/0018813 discloses a configuration for displaying tactile information to a person by adopting a driver using fluid and generating bubbles by adjusting fluid injected into each unit cell.

However, in the above techniques, the driver has a rigid structure, which is not easily attached to a human body, has a small driving displacement and is difficult to configure a system for providing tactile information.

### RELATED LITERATURES

### Patent Literature

U.S. Pat. No. 8,013,847 (Immersion Corporation), Sep. 6, 2011

US 2011/0018813 (Ezekiel Kruglick), Jan. 27, 2011

### SUMMARY

The present disclosure is directed to providing a tactile display device and method with a flexible structure which is closely adhered to a human body to transfer soft tactile sensation.

The present disclosure is also directed to providing a tactile display device and method which may effectively transfer tactile information by using a pneumatic force and an electromagnetic force.

In one aspect, there is provided a tactile display device, which includes: an actuator which is movable in a vertical direction when an electric current is applied thereto; and a body made of flexible material and having a receiving unit for receiving the actuator and a fluid channel allowing a pneumatic force from an outside to be transferred to the receiving unit, wherein a membrane made of flexible material and capable of vertical displacement is attached to an upper end of the receiving unit of the body, and the actuator is coupled to a lower portion of the membrane so that the membrane and the actuator have the same vertical displacement.

The body or the membrane may be manufactured by using PDMS.

The actuator may include a permanent magnet disposed to be fixed to a lower surface of the receiving unit of the body; and a core coupled to the lower portion of the membrane, a coil being wound around the core.

The tactile display device may further include a wire connected to the coil through the body.

A pneumatic force input port for introducing fluid may be formed at a terminal of the fluid channel.

The tactile display device may further include a tube connected to the pneumatic force input port.

In another aspect, there is provided a tactile display device, which includes: a plurality of actuators which is movable in a vertical direction when an electric current is applied thereto; and a body made of flexible material and having a plurality of receiving units for receiving the plurality of actuators and a fluid channel diverged to allow a pneumatic force from an outside to be transferred to each receiving unit, wherein a membrane made of flexible material and capable of vertical displacement is attached to an upper end of each of the plurality of receiving units, and each actuator is coupled to a lower portion of the membrane so that the membrane and the actuator have the same vertical displacement.

Each actuator may include a permanent magnet disposed to be fixed to a lower surface of the receiving unit of the body; and a core coupled to the lower portion of the membrane, a coil being wound around the core.

The tactile display device may further include a wire connected to the coil through the body.

The tactile display device may further include a controller for controlling an electric current applied to each actuator.

In one aspect, there is provided a tactile display method, which includes: transmitting a pneumatic force to each receiving unit via a fluid channel of a body; moving a plurality of actuators upwardly in a vertical direction by the pneumatic force; and applying an electric current to the plurality of actuators selectively, thereby controls a vertical displacement of each actuator by combination of pneumatic force and electromagnetic force.

The tactile display device and method of the present disclosure may be closely adhered to a human body in a natural manner due to its flexible structure and effectively transfer tactile information to the skin.

The tactile display device and method of the present disclosure may efficiently control the transfer of tactile information by using a pneumatic force and an electromagnetic force.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a perspective view showing a tactile display device according to an embodiment of the present disclosure;

FIG. 2 is a cross-sectional view taken along the ling A-A′ of FIG. 1;

FIGS. 3a to 3c are diagrams for illustrating an operation of an actuator of the present disclosure; and

FIGS. 4 and 5 are perspective views showing a tactile display device according to another embodiment of the present disclosure.

### DETAILED DESCRIPTION OF MAIN ELEMENTS

100: body

110: membrane

120: receiving unit

130: fluid channel

140: pneumatic force input port

200: actuator

210: permanent magnet

220: core

230: coil

300: tube

410, 420, 430, 440: receiving unit

510, 520, 530, 540: actuator

412, 422, 432, 442, 450: fluid channel

460: pneumatic force input port

600: tube

### DETAILED DESCRIPTION

Hereinafter, a tactile display device according to exemplary embodiments of the present disclosure will be described in detail with reference to the accompanying drawings.

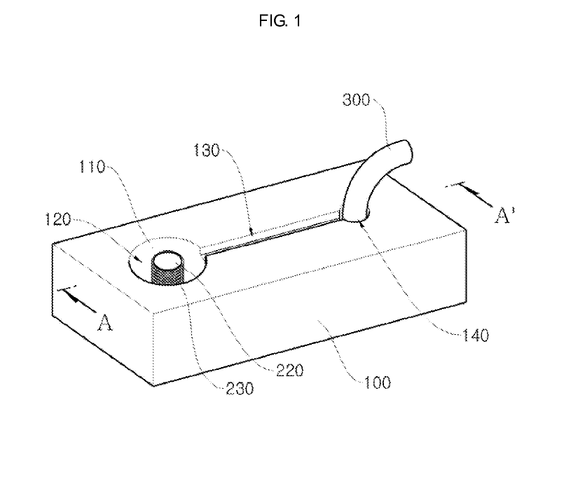

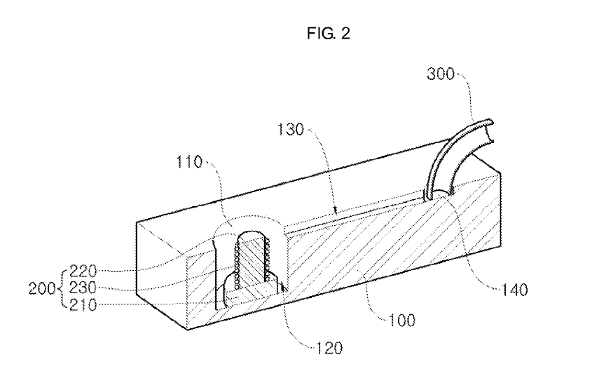

FIG. 1 is a perspective view showing a tactile display device according to an embodiment of the present disclosure, and FIG. 2 is a cross-sectional view taken along the ling A-A′ of FIG. 1.

Referring to FIGS. 1 and 2, a tactile display device of the present disclosure includes a body 100 and an actuator 200, and further includes a tube 300 selectively.

The body 100 is made of flexible material, for example polydimethylsiloxane (PDMS). The body 100 includes a receiving unit 120 for receiving the actuator 200, and a fluid channel 130 for allowing a pneumatic force from an outside to be transferred to the receiving unit 120. In FIGS. 1 and 2, the fluid channel 130 does not have an open upper portion and forms a single path along which fluid may move.

A pneumatic force input port 140 for introducing fluid may be formed at a terminal of the fluid channel 130, and a tube 300 may be connected to the pneumatic force input port 140 in order to easily apply a pneumatic force from the outside.

A membrane 110 made of flexible material and capable of vertical displacement is attached to the upper end of the receiving unit 120 of the body 100. If a pneumatic force is transferred from the outside to the receiving unit 120 through the fluid channel 130, the degree of expansion of the membrane 110 may vary according to the magnitude of the pneumatic force, and a user receives tactile information due to the expansion of the membrane 110. The membrane 110 may be a flexible PDMS membrane with optimized thickness and diameter of 100 μm and 5 mm, respectively, without being limited thereto. Since the membrane 110 is made of flexible material, a body of the user may be closely adhered to the membrane 110 and the user may also receive tactile information softly.

The actuator 200 is coupled to the lower portion of the membrane 110 and is movable in a vertical direction when an electric current is applied thereto. The dimension of the actuator 200 is designed to generate force and displacement sufficiently, and the force and displacement are critical parameters which transfer tactile information to the skin by means of mechanical simulation using the ANSYS workbench.

In an embodiment of the present disclosure, the actuator 200 may include a permanent magnet 210, a core 220 and a coil 230. The permanent magnet 210 is disposed to be fixed to the lower surface of the receiving unit 120 of the body 100, and the core 220 wound around the coil 230 is fixed to the lower portion of the membrane 110. Therefore, if a pneumatic force greater than the magnetic force of the permanent magnet 210 is applied and so the membrane 110 expands upwards due to the pneumatic force, the core 220 coupled to the lower portion of the membrane 110 also moves upwards together. In addition, if an electric current is applied to the coil 230 to generate an electromagnetic force between the core 220 and the permanent magnet 210 and so the core 220 moves downwards, the membrane 110 attached to the upper portion of the core 220 is also moved downwards. Meanwhile, though not shown in the figures, a wire (not shown) may be connected to the coil 230 through the body 100 so that an external device may apply an electric current to the coil 230 through the wire.

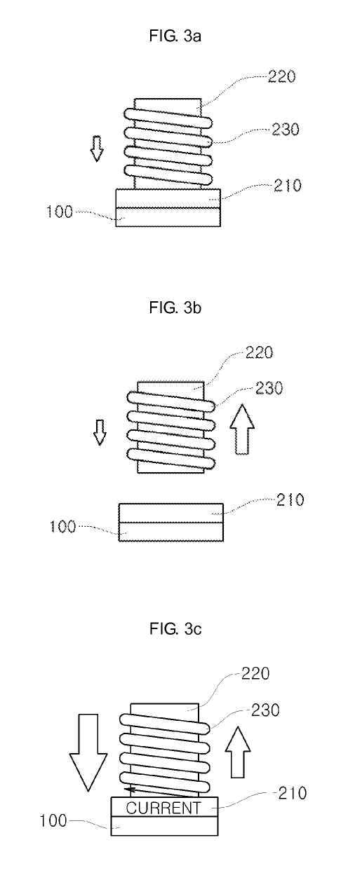

The operating principle of the present disclosure will be described in more detail with reference to FIGS. 3a to 3c.

FIGS. 3a to 3c are diagrams for illustrating an operation of the actuator of the present disclosure.

First, referring to FIG. 3a, at an initial stage, the core 220 maintains a holding state where the core 220 contacts the permanent magnet 210 due to the magnetic force of the permanent magnet 210. At this time, since the membrane 110 attached to the upper end of the core 220 does not generate a displacement, a user contacting the membrane 110 may not feel the change of tactile sensation.

In succession, in case of expanding the membrane 110 upwards to transfer tactile sensation to the user, if a pneumatic force applied from the outside is set greater than the magnetic force of the permanent magnet 210, the membrane 110 expands upwards, and the core 220 attached to the lower portion of the membrane 110 also moves upwards together. Therefore, as shown in FIG. 3b, the core 220 may be separated from the permanent magnet 210.

Subsequently, in case of moving the core 220 downwards again, if an electric current is applied to the coil 230, the core 220 moves downwards due to the electromagnetic force between the core 220 and the permanent magnet 210, and accordingly, the membrane 110 attached to the upper end of the core 220 also moves downwards. Meanwhile, even though FIG. 3c shows a state where the core 220 contacts the permanent magnet 210 according to an applied electric current, it is also possible to adjust a distance between the core 220 and the permanent magnet 210 by varying the amount of applied current. The vertical movement of the core 220 may be controlled according to the amount of applied current, and therefore, the user may feel the change of tactile sensation through the membrane 110 attached to the upper end of the core 220.

In other words, the tactile display device of the present disclosure transfers tactile information by combining the electromagnetic force and the pneumatic force and also operates by using the latching mechanism. If the latching mechanism is used, great tactile information may be transferred to the skin of the user by means of the membrane 110 vertically moving. An operating current required for the present disclosure may be implemented in a very low level, because the entire electromagnetic force needs to be just slightly greater than the pneumatic force. Therefore, the tactile display device of the present disclosure using the latching mechanism may have a great operating displacement and may also transfer great tactile sensation with a low operating current.

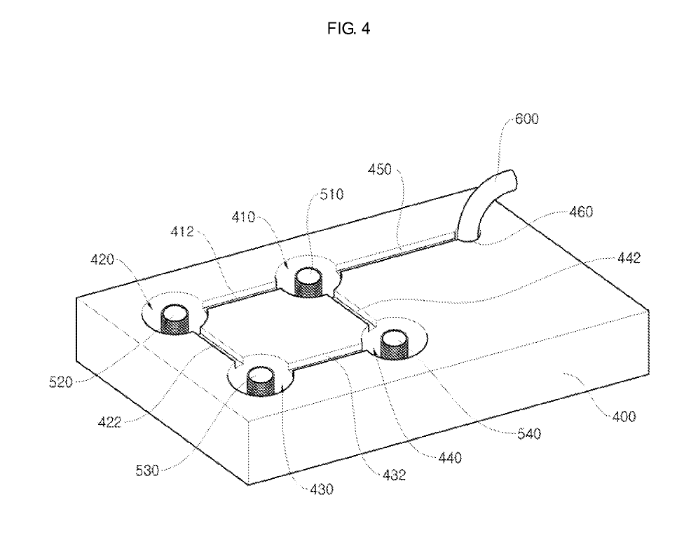

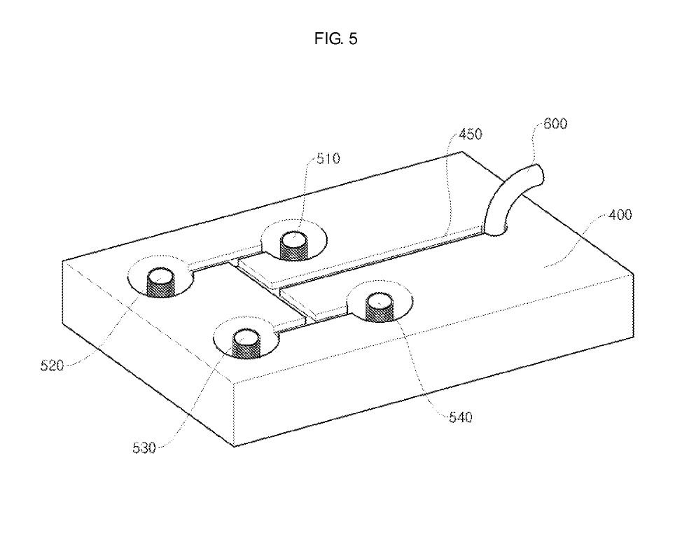

FIGS. 4 and 5 are perspective views showing a tactile display device according to another embodiment of the present disclosure.

First, referring to FIG. 4, actuators 510, 520, 530, 540 are arranged in a 2×2 matrix pattern, and a body 400 includes receiving units 410, 420, 430, 440 for receiving the actuators 510, 520, 530, 540, respectively. The membrane 110 of FIG. 1 is attached to each of the actuators 510, 520, 530, 540.

The body 400 includes a pneumatic force input port 460 and a fluid channel 450 which serve as an entrance and a pass for transferring an external pneumatic force, and a tube 600 may be coupled to the pneumatic force input port 460.

In FIG. 4, the fluid channel 450 communicates with the first receiving unit 410 and has diverged fluid channels 412, 422, 432, 442 for communicating with other receiving units 420, 430, 440.

The shape of the fluid channels 450, 412, 422, 432, 442 is not limited to the shape shown in FIG. 4, and for example, as shown in FIG. 5, the fluid channel 450 may be diverged to communicate with each of the receiving units 410, 420, 430, 440.

If a pneumatic force applied from the outside is transferred to each of the receiving units 410, 420, 430, 440 through the fluid channel 450, the membrane 110 expands upwards due to the pneumatic force, and accordingly, the actuators 510, 520, 530, 540 attached to the lower portion of the membrane 110 also move upwards with the same displacement. At this time, if the current applied to each of the actuators 510, 520, 530, 540 is controlled by using a controller (not shown), a displacement of each of the actuators 510, 520, 530, 540 may be controlled. Therefore, while some actuators are maintained in a state of being moved upwards, some actuators may be moved downwards. Accordingly, the user may receive various kinds of tactile information at various points of the body.

In the present disclosure, if the pneumatic force applied from the outside increases, the amount of current for controlling the actuators 510, 520, 530, 540 also increases. Therefore, in a state of where the pneumatic force is transferred, the amount of current to be transferred to the actuators 510, 520, 530, 540 may be adjusted to selectively control vertical displacement of the actuators 510, 520, 530, 540.

The tactile display device of the present disclosure may be closely adhered to a human body due to its flexible structure and may also transfer tactile sensation effectively. Therefore, the tactile display device of the present disclosure may be applied in various fields, for example, for giving realistic feeling in a virtual reality world, providing a haptic feedback in a mobile device, allowing a surgeon to feel tactile sensation contacted by a surgical operating robot, or the like.

While the exemplary embodiments have been shown and described, it will be understood by those skilled in the art that various changes in form and details may be made thereto without departing from the spirit and scope of the present disclosure as defined by the appended claims.

What is claimed is:

1. A tactile display device, comprising:
an actuator which is movable in a vertical direction when an electric current or a pneumatic force is applied thereto; and
a body made of flexible material and having a receiving unit for receiving the actuator and a fluid channel allowing a pneumatic force from an outside to be transferred to the receiving unit,
wherein a membrane made of flexible material and capable of vertical displacement is attached to an upper end of the receiving unit of the body, and the actuator is coupled to a lower portion of the membrane so that the membrane and the actuator have the same vertical displacement.

2. The tactile display device according to claim 1, wherein the body or the membrane is manufactured by using PDMS.

3. The tactile display device according to claim 1, wherein the actuator includes:
a permanent magnet disposed to be fixed to a lower surface of the receiving unit of the body; and
a core coupled to the lower portion of the membrane, a coil being wound around the core.

4. The tactile display device according to claim 3, further comprising a wire connected to the coil through the body.

5. The tactile display device according to claim 1, wherein a pneumatic force input port for introducing fluid is formed at a terminal of the fluid channel.

6. The tactile display device according to claim 5, further comprising a tube connected to the pneumatic force input port.

7. A tactile display device, comprising:
a plurality of actuators which is movable in a vertical direction when an electric current or a pneumatic force is applied thereto; and
a body made of flexible material and having a plurality of receiving units for receiving the plurality of actuators and a fluid channel diverged to allow a pneumatic force from an outside to be transferred to each receiving unit,
wherein a membrane made of flexible material and capable of vertical displacement is attached to an upper end of each of the plurality of receiving units, and each actuator is coupled to a lower portion of the membrane so that the membrane and the actuator have the same vertical displacement.

8. The tactile display device according to claim 7, wherein each actuator includes:
a permanent magnet disposed to be fixed to a lower surface of the receiving unit of the body; and
a core coupled to the lower portion of the membrane, a coil being wound around the core.

9. The tactile display device according to claim 8, further comprising a wire connected to the coil through the body.

10. The tactile display device according to claim 7, further comprising a controller for controlling an electric current applied to each actuator.

11. A tactile display method by using a tactile display device with a flexible structure which is closely adhered to a human body to transfer tactile sensation, the tactile display device comprises a plurality of actuators which is movable in a vertical direction when an electric current or a pneumatic force is applied thereto; and a body made of flexible material and having a plurality of receiving units for receiving the plurality of actuators and a fluid channel diverged to allow a pneumatic force from an outside to be transferred to each receiving unit, wherein a membrane made of flexible material and capable of vertical displacement is attached to an upper end of each of the plurality of receiving units, and each actuator is coupled to a lower portion of the membrane so that the membrane and the actuator have the same vertical displacement, the method comprising:
transmitting the pneumatic force to each receiving unit via the fluid channel of the body;
moving the plurality of actuators upwardly in the vertical direction by the pneumatic force; and
applying the electric current to the plurality of actuators selectively, thereby controls the vertical displacement of each actuator by combination of pneumatic force and electromagnetic force.
